(19) United States
(12) Patent Application Publication
(10) Pub. No.: US 2010/0193061 A1
(43) Pub. Date: Aug. 5, 2010

(54) INSULATION STRUCTURE FOR THE INSULATION OF DUCTS

(75) Inventors: Charles M. PRINCELL, Graham, NC (US); Kartik A. PATEL, Mebane, NC (US)

Correspondence Address: ROTHWELL, FIGG, ERNST & MANBECK, P.C., 1425 K STREET, N.W., SUITE 800, WASHINGTON, DC, 20005, US

(73) Assignee: ARMACELL ENTERPRISE GMBH, Muenster (DE)

(21) Appl. No.: 12/692,070

(22) Filed: Jan. 22, 2010

Related U.S. Application Data
(63) Continuation-in-part of application No. 12/236,926, filed on Sep. 24, 2008.
(60) Provisional application No. 61/083,779, filed on Jul. 25, 2008.

(30) Foreign Application Priority Data
Aug. 29, 2008 (EP) 08015316.6

(51) Int. Cl. F16L 3/00; F16L 9/14

(52) U.S. Cl. 138/107; 138/149

(57) ABSTRACT

A flexible, composite duct insulation structure includes a first layer forming an insulation layer, and a magnetic layer or strips for holding the insulation layer against a ferrous metal duct surface.

### CROSS-REFERENCE TO RELATED APPLICATION(S)

This application is a continuation-in-part of U.S. application Ser. No. 12/236,926, filed Sep. 24, 2008, which claims the benefit of U.S. Provisional Application No. 61/083,779, filed Jul. 25, 2008 and also claims priority from European Patent Application No. 08 015 316.6, filed Aug. 29, 2008, the disclosure of which is incorporated herein in its entirety by reference.

### BACKGROUND OF THE INVENTION

1. Field of the Invention

This invention relates to insulation structures and methods for the insulation of duct surfaces.

2. Description of the Background Art

Current application of low density thermal and/or acoustic insulation to the interior surface of annular duct systems typically requires a three component structure: (1) annular duct shell, (2) low density fiber, such as fiberglass, and (3) annular (perforated or solid) insulated retaining insert. (see FIG. 5). The purpose of the retaining insert is to hold the insulation material against the interior wall of the annular duct. Fiberglass insulation materials do not have sufficient structural integrity to maintain an unaided annular shape, and cannot be installed in annular ducts without the use of strong adhesives, mechanical fasteners and/or annular retaining inserts. The use of limited open time contact adhesives is prohibitive due to health hazards and surface area application limits associated with short setup time. The installation of metal retaining inserts is costly, requires special safety equipment and practices, reduces the NRC (noise reduction coefficient) of the installed insulation, and increases the installed weight of the duct sections by ⅓ or greater.

Prior attempts to replace fiberglass with closed cell elastomer and polymer foams have all resulted in failure. Closed cell foams are extremely difficult to install between the duct shell and insulation retaining insert due to the magnitude of the resulting insertion force.

There remains a need in the art for improved insulation structures and methods for the insulation of duct surfaces.

### SUMMARY OF THE INVENTION

In accordance with one embodiment of the invention, a duct insulation comprises a first layer forming an insulation layer, and a magnetic means connected to the insulation layer for attaching the insulation layer to a ferrous metal duct structure.

### BRIEF DESCRIPTION OF THE DRAWINGS

FIG. 1 is a perspective view of one embodiment showing layers of a composite insulation system.

FIG. 2 is a perspective end view of one embodiment showing the configuration of the composite insulation system in a substantially annular duct; and

FIG. 3 is a detailed cross-sectional view of section A of the end view of FIG. 2.

FIG. 4 is a schematic view of a second embodiment showing magnetic strips.

FIG. 5 is a perspective expanded end view of prior annular duct insulation systems.

FIG. 6 is a perspective end view of the second embodiment with magnetic strips.

FIG. 7A is a cross-section of the second embodiment of FIG. 6.

FIG. 7B is a detail of the second embodiment of FIG. 7A.

### DETAILED DESCRIPTION OF THE INVENTION

In one embodiment, a low-density annular duct insulation system comprises a layered composite structure that can be formed into an annular configuration and easily installed and held securely in place to the interior wall of a ferrous metal annular duct through magnetic force.

The present invention according to certain embodiments provides a flexible duct insulation structure comprising a first insulation layer and a magnetic means connected to the insulation layer for attaching the insulation layer to a ferrous metal duct structure. The magnetic means may be adhered to the first layer by an adhesive to form a composite structure. Such a composite insulation structure may be held against an inner annular surface wall of a ferrous metal tubular duct without additional spring structure or retaining structure.

Alternatively, a composite insulation structure according to the invention can be held against an outer annular surface wall of a ferrous metal tubular duct (not shown).

In other embodiments, sheets of duct insulation structure according to the invention can be held against inner and/or outer planar surfaces of rectangular ferrous duct surfaces, or other ferrous ducts having substantially planar surfaces (not shown).

According to certain embodiments, the magnetic force required to prevent the inventive insulation structure from collapsing on itself or falling away from the ferrous duct may merely be that required to overcome gravity. This is dependent on the density and thickness of the composite being used and the diameter of the duct being insulated, and can easily be determined by persons skilled in the art.

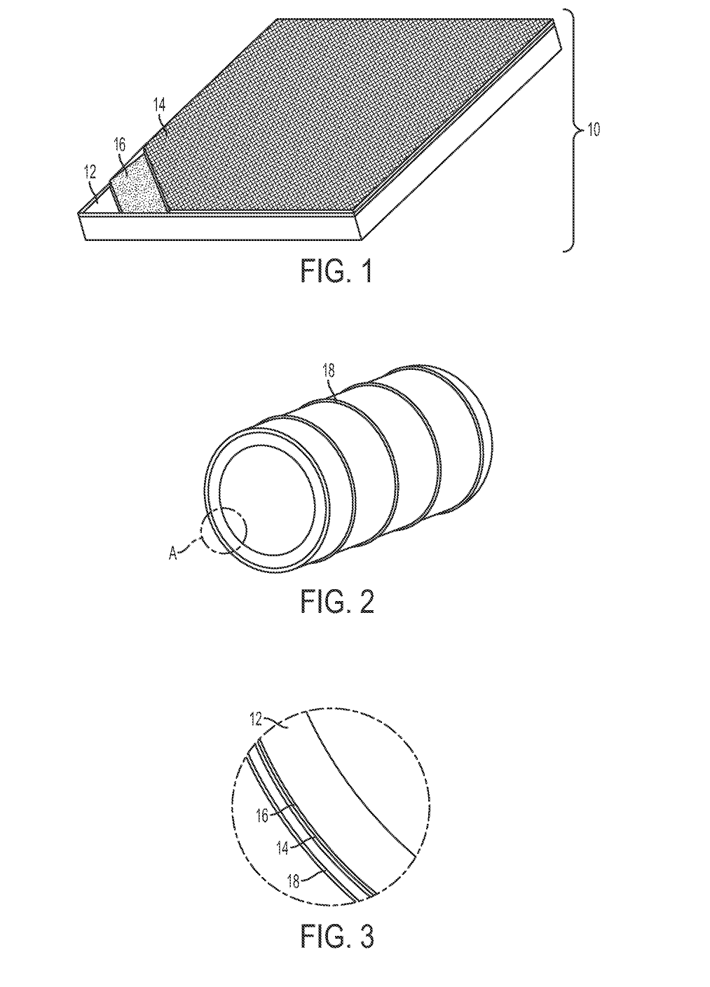

According to certain embodiments, as illustrated in FIG. 1 a composite insulation structure 10 of the invention comprises a first outer layer 12 of insulation material and a second inner magnetic layer 14. The first layer 12 may be adhered to the second layer by an adhesive 16. The insulation layer 12 can be formed from any material suitable for insulating ducts, such as elastomeric foams, thermoplastic foams, thermo-set polymer foams, and fiber insulation materials.

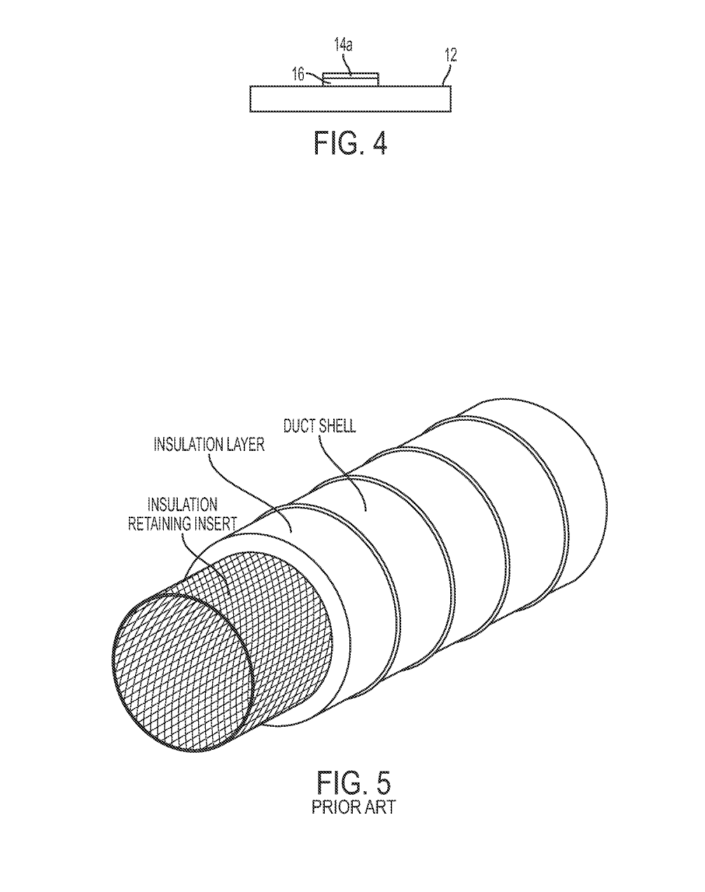

As shown in FIGS. 4, 6, 7A and 7B, the structure may comprise insulation layer 12 with magnetic strips 14a attached thereto with adhesive 16.

Open- or closed-cell type elastomeric foams, and cross-linked foams may be used for the insulation layer 12. Any suitable elastomeric foam materials can be used, including but not limited to, Ethylene-propylene (EPDM), Nitrile (NBR), Styrene-butadiene (SBR), Polybutadiene (BR), Natural rubber (NR), Chloroprene (CR), Butyl and Halobutyl (IIR, BIIR, CIIR), Silicone (MQ), Blends with compatible rubbers, e.g. Styrene-butadiene and polybutadiene, Blends with compatible resins, e.g., Nitrile and polyvinyl chloride.

In another embodiment, the insulation layer 12 is formed from a thermoplastic foam, such as cross-linked polyethylene, non-cross-linked polyethylene, polypropylene, polyvinylchloride, polyethylene terephthalate, or polyurethane.

In another embodiment, the insulation layer 12 may be formed from fiber insulation material, such as fiberglass, organic fibers, or a combination thereof.

In another embodiment, the insulation layer 12 may be formed from an organic fiber, such as cotton, polyester, or a combination thereof.

The insulation layer thickness may be any suitable thickness, for example, about 1-150 mm, e.g., about 10-100 mm.

The magnetic layer or strip thickness may be any suitable thickness, for example, from about 0.1-2 mm, such as, about 0.2-1.5 mm (e.g., about 8-60 mil).

The insulation layer 12 may be attached to the magnetic layer or strips using any suitable adhesive 16 for adhering insulating materials. The adhesive 16 may be contact- or pressure-sensitive adhesive, e.g., hotmelt pressure sensitive adhesive. The adhesive 16 may be acrylic hydrocarbon solvent-based or water-based.

The adhesive thickness may be any suitable thickness, for example, about 0.01-2 mm.

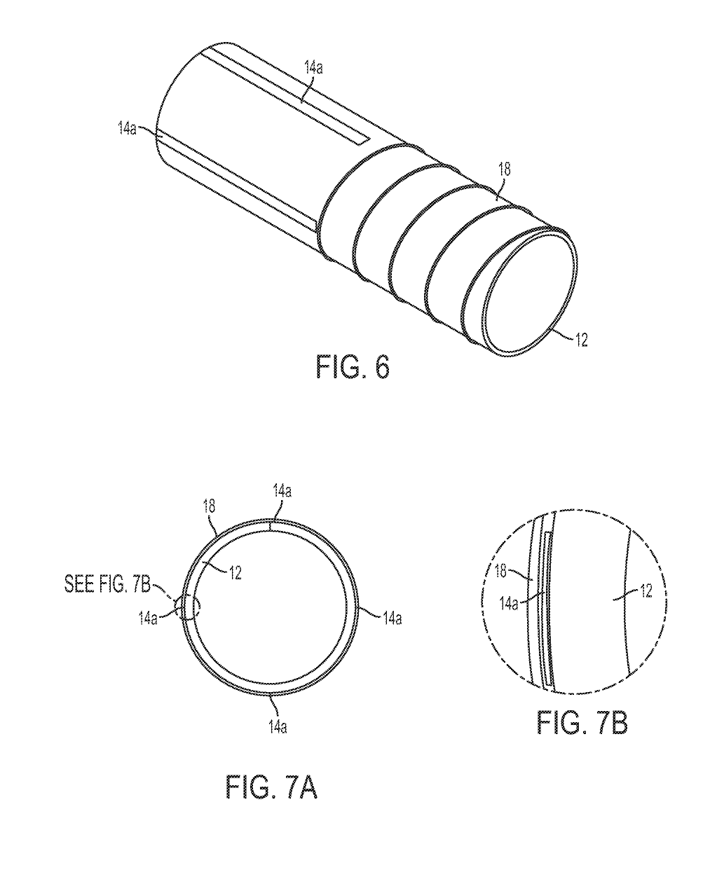

According to certain embodiments, the composite duct insulation holds the duct insulation structure 10 against an inner annular surface wall of a ferrous metal tubular duct 18 without additional spring structure or retaining structure. The duct insulation structure 10 can be positioned within an annular duct 18 as shown in FIGS. 2 and 6.

In one embodiment, the insulation layer 12 is oriented inwardly toward the center of an annular duct, and the magnetic layer or strips are oriented outwardly toward the inner annular surface wall of tubular duct 18.

The invention further comprises methods for attaching said composite insulation structure 10 to the interior wall of a duct 18. The method comprises 1) cutting the duct insulation structure, 2) rolling said duct insulation into an annular shape, and 3) positioning the annular shaped insulation against an interior wall of a duct by magnetic force alone so as to hold the insulation structure against the interior wall of a ferrous metal tubular duct without additional spring structure or retaining structure.

While the composite insulation structure 10 illustrated in the figures only show one insulation layer 12, additional layers and coatings may be included in the composite insulation structure.

In describing the invention, certain embodiments have been used to describe the invention. However, the invention is not limited to these embodiments as other embodiments of the present invention will readily occur to those skilled in the art after reading this specification.

We claim:

1. A duct insulation structure comprising a first layer forming an insulation layer, and magnetic means connected to the insulation layer for attaching the insulation layer to a ferrous metal duct structure.

2. The duct insulation of claim 1 wherein said magnetic means comprises a plurality of magnetic structure attached to the insulation layer.

3. The duct insulation of claim 4 wherein said magnetic structures are magnetic strips attached to the insulation layer by adhesive.

4. The duct insulation of claim 1 wherein the magnetic means is attached to an outer surface of said insulation layer so as to hold said duct insulation against an inner annular surface wall of a ferrous metal tubular duct without additional spring structure or retaining structure.

5. The duct insulation of claim 1, wherein said insulation layer is formed from a material selected from the group consisting of elastomeric foams, thermo plastic foams, thermo-set polymer foams, and fiber insulation materials.

6. The duct insulation of claim 5, wherein said elastomeric foams are cross-linked.

7. The duct insulation of claim 5, wherein said elastomeric foams are of open- or closed-cell type.

8. The duct insulation of claim 6, wherein said elastomeric foam is selected from the group consisting of Ethylene-propylene (EPDM), Nitrile (NBR), Styrene-butadiene (SBR), Polybutadiene (BR), Natural rubber (NR), Chloroprene (CR), Butyl and Halobutyl (IIR, BIIR, CIIR), Silicone (MQ), blends with compatible rubbers, blends of Styrene-butadiene and polybutadiene, blends with compatible resins or, blends of Nitrile and polyvinyl chloride.

9. The duct insulation of claim 5, wherein said thermo plastic foam is selected from the group consisting of cross-linked polyethylene, non-cross-linked polyethylene, polypropylene, polyvinylchloride, polyethylene terephthalate, and polyurethane.

10. The duct insulation of claim 5, wherein said fiber insulation material is selected from the group consisting of fiberglass, organic fibers, or a combination thereof.

11. The duct insulation of claim 10, wherein said organic fiber is selected from the group consisting of cotton, polyester, or a combination thereof.

12. The duct insulation of claim 1, wherein said insulation layer has a thickness of about 1-150 mm.

13. The duct insulation of claim 3, wherein said adhesive has a thickness of about 0.01-2 mm.

14. The duct insulation of claim 3, wherein said magnetic strips have a thickness of about 0.1-2 mm.

15. The duct insulation of claim 1 wherein said magnetic means comprises a layer of magnetic sheet material attached to a surface of said first layer.

16. The duct insulation of claim 15 wherein said magnetic sheet material is attached to said surface of said first layer by adhesive.

17. The duct insulation of claim 1 wherein the magnetic means is attached to an outer surface of said insulation layer so as to hold said duct insulation against an inner annular surface wall of a ferrous metal tubular duct without additional spring structure or retaining structure.

18. The duct insulation of claim 1 wherein said structure is flexible.

19. The duct insulation structure of claim 14 wherein said strips have a width of about 10-100 mm.

20. The duct insulation structure of claim 14 wherein said strips have a width of about 50-75 mm.
